(19) United States
(12) Patent Application Publication
(10) Pub. No.: US 2023/0243640 A1
(43) Pub. Date: Aug. 3, 2023

(54) EXPANSION/CONTRACTION AMOUNT CALCULATION DEVICE, INDIVIDUAL IDENTIFICATION DEVICE, AND COMPUTER READABLE MEDIUM

(71) Applicant: HONDA MOTOR CO., LTD., Tokyo (JP)

(72) Inventors: Atsushi SAKURAI, Saitama (JP); Yuji ISOGAI, Saitama (JP); Hideki SAKAI, Saitama (JP); Tatsuya HATTORI, Saitama (JP)

(21) Appl. No.: 18/148,394

(22) Filed: Dec. 29, 2022

(30) Foreign Application Priority Data
Feb. 1, 2022 (JP) 2022-014278

(51) Int. Cl. G01B 11/16; G06T 7/73; G06V 20/64; G06V 10/75; H01M 10/48

(52) U.S. Cl. CPC G01B 11/16; G06T 7/74; G06V 20/64; G06V 10/757; H01M 10/48; G06T 2207/30108; G06T 2207/10081; G06T 2200/04; G06T 2207/10121

(57) ABSTRACT

An expansion/contraction amount calculation device 1 calculates an amount of deformation of an electrode by calculating an amount of expansion/contraction of the electrode based on 3D data of the electrode. The expansion/contraction amount calculation device 1 includes a controller 10 including: a feature point identifier 11 configured to identify a feature point from arrangement information regarding a piece of an active material, the arrangement information being included in the 3D data; a coordinate generator 12 configured to generate, based on relative positional information regarding the feature point, a coordinate system for calculation of the amount of deformation; and a calculator 14 configured to calculate, by comparing first 3D data with second 3D data, the amount of expansion/contraction of the electrode and the amount of deformation of the electrode.

This application is based on and claims the benefit of priority from Japanese Patent Application No. 2022-014278, filed on 1 Feb. 2022, the content of which is incorporated herein by reference.

### BACKGROUND OF THE INVENTION

### Field of the Invention

The present invention relates to an expansion/contraction amount calculation device, an individual identification device, and a computer readable medium.

### Related Art

Fingerprint identification is conventionally known as one of biometric authentication methods (for example, see Japanese Patent No. 6927611). For the fingerprint identification, a feature point, which is an end or a branch point of a line in a fingerprint, is detected based on an image produced by way of thinning.
Patent Document 1: Japanese Patent No. 6927611

### SUMMARY OF THE INVENTION

The conventional feature point detection described above is used for fingerprint identification, and cannot be applied as it is to calculation of an amount of deformation of an electrode in a battery, based on an amount of expansion/contraction of the electrode.

It is an object of the present invention to provide an expansion/contraction amount calculation device, an individual identification device, and a computer readable medium that are for calculating an amount of deformation of an electrode based on an amount of expansion/contraction of the electrode and enable identification of a feature point included in 3D data of the electrode, thereby contributing to improvement of energy efficiency of the battery.

An expansion/contraction amount calculation device (e.g., an expansion/contraction amount calculation device 1 to be described later) according to an embodiment of the present invention calculates an amount of deformation of an electrode by calculating an amount of expansion/contraction of the electrode based on 3D data of the electrode, the 3D data including first 3D data and second 3D data. The expansion/contraction amount calculation device includes a controller (e.g., a control device 10 to be described later) including: a feature point identifier (e.g., a feature identifier 11 to be described later) configured to identify a feature point from arrangement information regarding a piece of an active material, the arrangement information being included in the 3D data; a coordinate generator (e.g., a coordinate generator 12 to be described later) configured to generate, based on relative positional information regarding the feature point, a coordinate system for calculation of the amount of deformation; and a calculator (calculator 14 to be described later) configured to calculate, by comparing the first 3D data with the second 3D data, the amount of expansion/contraction of the electrode and the amount of deformation of the electrode.

According to this embodiment, it is preferable that the arrangement information regarding the piece of the active material includes at least one of a size, a shape, a quantity, or relative positional information of a plurality of the pieces of the active material that are arranged close to one another.

According to this embodiment, it is preferable that the coordinate generator generates the coordinate system for calculation of the amount of deformation, based on relative positional information regarding the feature point with respect to a current collector foil or relative positional information regarding a plurality of the feature points, as the relative positional information.

According to this embodiment, it is preferable that the electrode includes a mixture containing the active material and ceramic particles, and the feature point identifier identifies the feature point from arrangement information regarding a piece of the active material and the ceramic particles.

According to this embodiment, it is preferable that the arrangement information regarding the piece of the active material and the ceramic particles includes at least one of a size, a shape, a quantity, or relative positional information of a plurality of the pieces of the active material and the ceramic particles that are arranged close to one another.

According to this embodiment, it is preferable that the 3D data of the electrode pertains to a partial region of an entirety of the electrode, and includes relative positional information regarding the partial region with respect to the entirety of the electrode.

A computer readable medium according to an embodiment of the present invention stores an expansion/contraction amount calculation program for causing a computer to function as an expansion/contraction amount calculation device that calculates an amount of deformation of an electrode by calculating an amount of expansion/contraction of the electrode based on 3D data of the electrode, the 3D data including first 3D data and second 3D data. The expansion/contraction amount calculation device includes a controller (e.g., a control device 10 to be described later) including: a feature point identifier (e.g., a feature point identifier 11 to be described later) configured to identify a feature point from arrangement information regarding a piece of an active material, the arrangement information being included in the 3D data; a coordinate generator (e.g., a coordinate generator 12 to be described later) configured to generate, based on relative positional information regarding the feature point, a coordinate system for calculation of the amount of deformation; and a calculator (e.g., a calculator 14 to be described later) configured to calculate, by comparing the first 3D data with the second 3D data, the amount of expansion/contraction of the electrode and the amount of deformation of the electrode.

An individual identification device according to an embodiment of the present invention is for performing individual identification of an electrode based on 3D data of the electrode, the 3D data including first 3D data and second 3D data. The individual identifier includes a controller including: a feature point identifier (e.g., a future point identifier 11 to be described later) configured to identify a feature point from arrangement information regarding a piece of an active material, the arrangement information being included in the 3D data; and an individual identifier (e.g., an individual identifier 13 to be described later) configured to compare the first 3D data including the feature point with the second 3D data including the feature point, and to perform individual identification of the electrode based on information regarding the feature point included in the first 3D data and information regarding the feature point included in the second 3D data.

According to this embodiment, it is preferable that the arrangement information regarding the piece of the active material includes at least one of a size, a shape, a quantity, or relative positional information of a plurality of the pieces of the active material that are arranged close to one another.

According to this embodiment, it is preferable that the individual identifier performs individual identification of the electrode, based on at least one of arrangement information regarding pieces of the active material arranged close to the feature point, relative positional information regarding the feature point, or a number of current collector foils present between a plurality of the feature points.

According to this embodiment, it is preferable that the electrode includes a mixture containing the active material and ceramic particles, and the feature point identifier identifies the feature point from arrangement information regarding a piece of the active material and the ceramic particles.

According to this embodiment, it is preferable that the arrangement information regarding the piece of the active material and the ceramic particles includes at least one of a size, a shape, a quantity, or relative positional information of a plurality of the pieces of the active material and the ceramic particles that are arranged close to one another.

According to this embodiment, it is preferable that the 3D data of the electrode pertains to a partial region of an entirety of the electrode, and includes relative positional information regarding the partial region with respect to the entirety of the electrode.

A computer readable medium according to an embodiment of the present invention stores an individual identification program for causing a computer to function as an individual identification device that performs individual identification of an electrode based on 3D data of the electrode, the 3D data including first 3D data and second 3D data. The individual identification device includes a controller including: a feature point identifier (e.g., a feature point identifier 11 to be described later) configured to identify a feature point from arrangement information regarding a piece of an active material, the arrangement information being included in the 3D data; and an individual identifier (e.g., an individual identifier 13 to be described later) configured to compare the first 3D data including the feature point with the second 3D data including the feature point, and to perform individual identification of the electrode based on information regarding the feature point included in the first 3D data and information regarding the feature point included in the second 3D data.

The present invention provides an expansion/contraction amount calculation device, an individual identification device, and a computer readable medium that are for calculating an amount of deformation of an electrode based on an amount of expansion/contraction of the electrode and enable identification of a feature point included in 3D data of the electrode, thereby contributing to improvement of energy efficiency of the battery.

### BRIEF DESCRIPTION OF THE DRAWINGS

FIG. 1 is a diagram illustrating a configuration of an expansion/contraction amount calculation device according to a first embodiment of the present invention;

FIG. 2 is a diagram illustrating identification of a plurality of feature points by the expansion/contraction amount calculation device according to the first embodiment of the present invention;

FIG. 3 is a flowchart illustrating calculation of an amount of deformation by the expansion/contraction amount calculation device according to the first embodiment of the present invention;

FIG. 4 is a diagram illustrating identification of a plurality of feature points by an expansion/contraction amount calculation device according to a second embodiment of the present invention; and

FIG. 5 is a flowchart illustrating calculation of an amount of deformation by the expansion/contraction amount calculation device according to the second embodiment of the present invention.

### DETAILED DESCRIPTION OF THE INVENTION

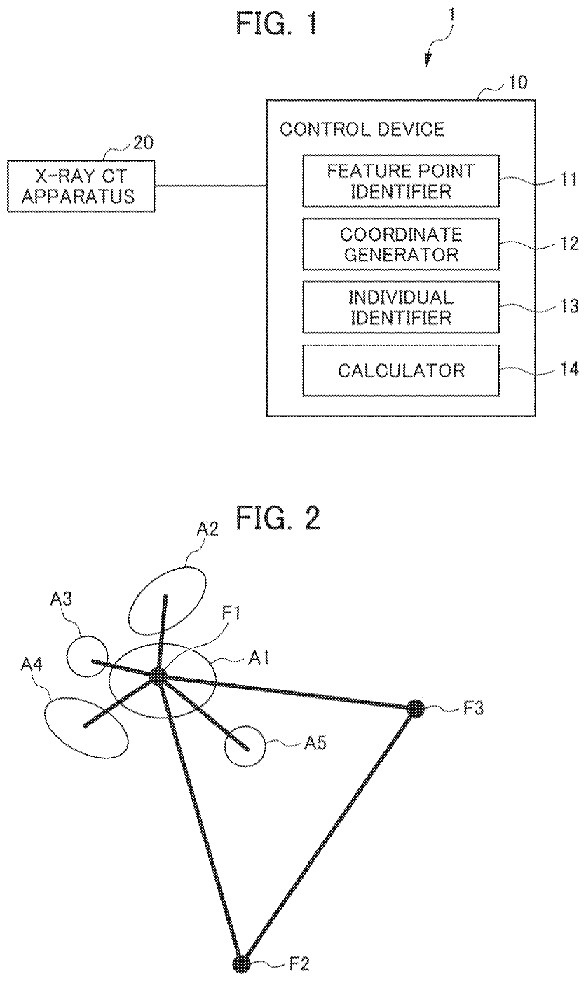

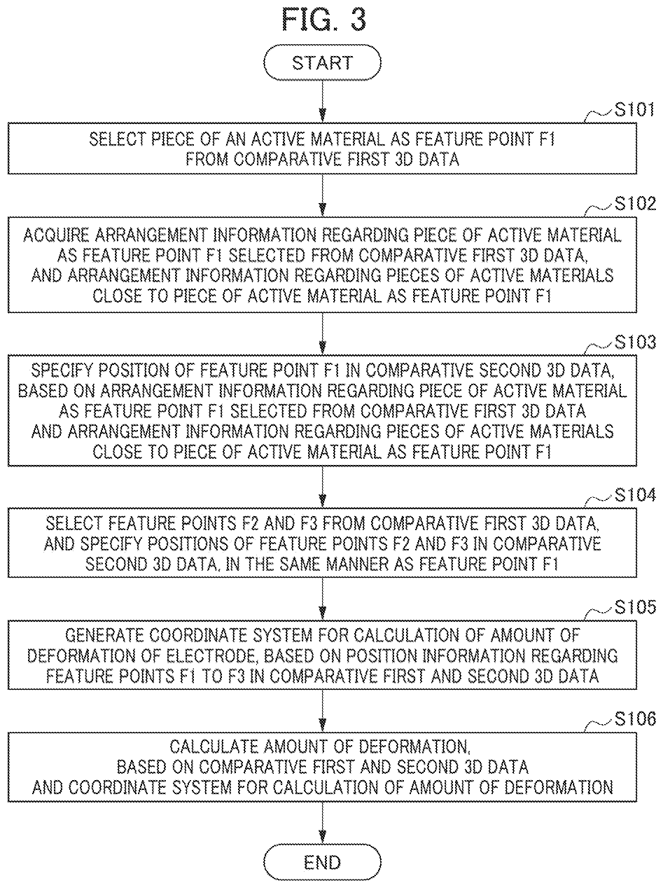

A first embodiment of the present invention will be described below. FIG. 1 is a diagram illustrating a configuration of an expansion/contraction amount calculation device 1. FIG. 2 is a diagram illustrating identification of a plurality of feature points F1 to F3 performed by the expansion/contraction amount calculation device 1. FIG. 3 is a flowchart illustrating calculation of an amount of deformation performed by the expansion/contraction amount calculation device 1.

The expansion/contraction amount calculation device 1 includes a control device 10 and an X-ray CT apparatus 20, and is capable of calculating an amount of deformation of an electrode on the basis of an amount of expansion/contraction of the electrode. The calculation of an amount of deformation of an electrode involves a comparison between 3D data captured and generated by the X-ray CT apparatus 20 before deformation and 3D data captured and generated by the X-ray CT apparatus 20 after deformation. In this respect, it is necessary to individually identify which portion of the 3D data before deformation corresponds to which portion of the 3D data after deformation. For this purpose, the expansion/contraction amount calculation device 1 includes an individual identification device that performs individual identification of an electrode.

The X-ray CT apparatus 20 scans the entire periphery of an electrode of a battery such as a lithium-ion battery. Specifically, an electrode of a battery as a subject is irradiated with X-rays generated in an X-ray tube, and an X-ray detector provided at a position frontally opposite to the X-ray tube across the electrode detects the x-rays, thereby obtaining a fluoroscopic image. This operation is repeatedly performed while rotating the electrode of the battery by 360° at a predetermined speed using a rotary device (not shown), whereby fluoroscopic images are captured in all directions over the entire periphery. Subsequently, transmissivity at arbitrary points on the electrode is determined based on information contained in the fluoroscopic images captured in all the directions over the entire periphery, so that 3D data is reconstructed and outputted to the control device 10. Accordingly, the 3D data pertains to a partial region of the entirety of the electrode, and the partial region is the portion where the fluoroscopic images are captured in all the directions over the entire periphery while the electrode is rotated by 360°. The 3D data includes relative positional information indicating which region of the entirety of the electrode corresponds to the partial region.

The control device 10 includes a feature point identifier 11, a coordinate generator 12, an individual identifier 13, and a calculator 14. These are implemented by, for example, a hardware processor such as a CPU executing a program. The program may be stored in advance in a storage such as a SSD, a HDD, or a flash memory. Alternatively, the program may be stored in a detachable storage medium such as a DVD or a CD-ROM, and may be installed in the storage upon mounting of the storage medium to a drive. The control device 10 includes a storage (not shown), and the storage includes a SSD, a HDD, a flash memory, a ROM, a RAM, and the like.

The feature point identifier 11 receives an input of 3D data generated from images of an electrode of a battery captured by the X-ray CT apparatus 20. The feature point identifier 11 then identifies feature points from arrangement information regarding a plurality of pieces of active materials, the arrangement information being included in the 3D data. Specifically, a positive electrode of a battery contains, as a positive electrode active material, a layered positive electrode active material such as LiCoO₂ or LiNiO₂, a spinel positive electrode active material such as LiMn₂O₄ or LiCoMnO₄, and an olivine positive electrode active material such as LiCoPO₄ or LiMnPO₄. A negative electrode of a battery contains, as a negative electrode active material, graphite such as artificial graphite or natural graphite, hard carbon, soft carbon, or a silicon-based material such as a Si metal or a Si compound. The 3D data, which is generated from images of an electrode of a battery captured by the X-ray CT apparatus 20, includes images of a plurality of pieces of the active materials.

For example, the arrangement information regarding the plurality of pieces of the active materials includes at least one of a size, a shape, a quantity, or relative positional information of the plurality of pieces of the active materials arranged close to one another. For example, it is possible to use, as the size and shape of one piece of the active material, a ratio between a long diameter as the maximum diameter and a short diameter as the minimum diameter of the one piece of the active material. For example, it is possible to use, as the quantity of the active materials, a quantity of pieces of the active materials included in a predetermined range from a predetermined piece of the active material. For example, it is possible to use, as the relative positional information of the plurality of pieces of the active materials, information regarding relative position of a predetermined piece with respect to another piece of the active materials.

For example, the feature point identifier 11 identifies a feature point in the manner illustrated in FIG. 2. Specifically, in a case where a plurality of pieces A1 to A5 of the active materials are arranged close to one another, the feature point identifier 11 identifies, as a feature point, a center of gravity F1 of the piece A1 of the active material whose maximum diameter is larger than the maximum diameters of the other pieces of the active materials.

The coordinate generator 12 generates a coordinate system for calculation of an amount of deformation, based on the relative positional information regarding the feature point F1 or a feature point F. Specifically, for example, as illustrated in FIG. 2, once three feature points F1, F2, and F3 are identified by the feature point identifier 11, a coordinate system can be specified in an image of the 3D data by way of the three points (the feature points F1, F2, and F3). The coordinate generator 12 generates a coordinate system based on the three points. Specifically, for example, the coordinate generator 12 generates a coordinate system having coordinate axes whose origin is set at the feature point F1, and then, calculates coordinates of the feature points F2 and F3.

The individual identifier 13 compares 3D data of the electrode before deformation as first 3D data including the feature point F1, with 3D data of the electrode after deformation as second 3D data including the feature point F1. The individual identifier 13 then performs individual identification of the electrode, based on information regarding the feature point F1 in the 3D data of the electrode before deformation and information regarding the feature point F1 in the 3D data of the electrode after deformation.

For example, it is possible to use, as the information regarding the feature point F1 for use in the individual identification of the electrode, one or more selected from arrangement information regarding the pieces of the active materials arranged close to the feature point F1, relative positional information regarding the plurality of feature points F1, F2, and F3, and the number of current collector foils forming portions of the electrode between the plurality of feature points F1, F2, and F3.

The calculator 14 compares the 3D data of the electrode before deformation including the feature point F1, with the 3D data of the electrode after deformation including the feature point F1, to thereby calculate an amount of expansion/contraction and an amount of deformation of the electrode. Specifically, for example, for each of the 3D data of the electrode before deformation and the 3D data of the electrode after deformation, the calculator 14 calculates distances between the feature points F1, F2, and F3, from the coordinates of the feature points F2 and F3 with respect to the coordinate axes whose origin is set at the feature point F1. Subsequently, the calculator 14 determines differences in the respective distances between the 3D data of the electrode before deformation and the 3D data of the electrode after deformation, and thereby calculates an amount of expansion/contraction of the electrode, and then, calculates an amount of deformation based on the amount of expansion/contraction.

Next, a process (control by the control device 10) will be described which is performed by the control device 10 executing a program according to the present embodiment stored in the storage medium. First, as illustrated in FIG. 3, the control device 10 controls the X-ray CT apparatus 20 so that the X-ray CT apparatus 20 scans an electrode of a battery over the entire periphery while the electrode is rotated by 360°, captures X-ray fluoroscopic images in respective directions over the entire periphery, and outputs the captured images as 3D data to the control device 10. In Step S101, the feature point identifier 11 selects a piece of an active material suitable as a feature point F1 from 3D data of the electrode before deformation (hereinafter referred to as “first 3D data”), and identifies the center of gravity of the piece of the active material as the feature point F1. The control device 10 then proceeds to Step S102 of the process.

In Step S102, the control device 10 acquires arrangement information regarding the piece of the active material having the feature point F1 identified from the first 3D data and arrangement information regarding pieces of active materials arranged close to the piece of the active material having the feature point F1. The control device 10 then proceeds to Step S103 of the process.

In Step S103, the control device 10 specifies a position of the feature point F1 in 3D data of the electrode after deformation (hereinafter referred to as “second 3D data”), based on the arrangement information regarding the piece of the active material having the feature point F1 and the arrangement information regarding the pieces of the active materials arranged close to the piece of the active material having the feature point F1, which have been identified from the first 3D data. The control device 10 then proceeds to Step S104 of the process.

In Step S104, the control device 10 specifies the positions of feature points F2 and F3, which are different from the feature point F1, in the same manner as in Steps S101 to S103 via which the position of the feature point F1 has been identified.

Specifically, similarly to the case of the feature point F1, the control device 10 selects pieces of the active materials suitable as the feature points F2 and F3, and identifies the center of gravity of the respective pieces of the active materials as the feature points F2 and F3. Next, the control device 10 acquires arrangement information regarding the pieces of the active materials respectively having the feature points F2 and F3 identified from the first 3D data and arrangement information regarding pieces of the active materials arranged close to the pieces having the feature points F2 and F3. Subsequently, the control device 10 specifies the positions of the feature points F2 and F3 in the second 3D data, based on the arrangement information regarding the pieces of the active materials having the feature points F2 and F3 and the arrangement information regarding the pieces of the active materials arranged close to the pieces having the feature points F2 and F3, which have been identified from the first 3D data. The control device 10 then proceeds to Step S105 of the process.

In Step S105, the coordinate generator 12 of the control device 10 generates, for each of the first 3D data and the second 3D data, coordinate axes whose origin is set at the feature point F1, using the positional information regarding the feature points F1 to F3, and generates coordinates of the feature points F2 and F3 with respect to the generated coordinate axes. The control device 10 then proceeds to Step S106 of the process.

In Step S106, the calculator 14 of the control device 10 calculates an amount of deformation of the electrode by calculating an amount of expansion/contraction of the electrode based on the coordinates of the feature points F1 to F3 with respect to the coordinate axes generated for the first 3D data by the coordinate generator 12 and those with respect to the coordinate axes generated for the second 3D data by the coordinate generator 12. The control device 10 then ends the process.

The present embodiment provides the following effects. According to the present embodiment, the expansion/contraction amount calculation device 1 includes the control device 10 including: the feature point identifier 11 configured to identify feature points F1 to F3 from arrangement information regarding pieces of active materials included in 3D data; the coordinate generator 12 configured to generate a coordinate system for calculation of an amount of deformation, based on relative positional information regarding the feature points F1 to F3; and the calculator 14 configured to calculate, by comparing first 3D data with second 3D data, an amount of expansion/contraction and an amount of deformation of the electrode.

Thus, using the 3D data obtained by the X-ray CT apparatus 20 makes it possible to set a reference based on which the amount of deformation is calculated by way of observation of a non-broken surface. Furthermore, the amount of deformation can be calculated even when the electrode has turned or non-uniform deformation has occurred in the electrode.

Moreover, in the present embodiment, the arrangement information regarding the pieces of active materials includes at least one of a size, a shape, a quantity, or relative positional information of the plurality of pieces of the active materials arranged close to one another. This makes it possible to easily and accurately acquire the arrangement information regarding the pieces of the active materials.

Further, according to the present embodiment, the coordinate generator 12 generates a coordinate system for calculation of an amount of deformation, based on relative positional information regarding the plurality of feature points F1 to F3, as the relative positional information. This makes it possible to generate coordinate axes with respect to which the coordinates of the feature points F1 to F3 are easily generated.

According to the present embodiment, the individual identification device includes a control device 10 including: a feature point identifier 11 configured to identify a feature point from arrangement information regarding pieces of active materials included in 3D data; and an individual identifier 13 configured to compare first 3D data including the feature point with second 3D data including the feature point, and to perform individual identification of an electrode based on information regarding the feature point included in the first 3D data and the feature point included in the second 3D data.

This configuration makes it possible to easily determine whether or not a portion of the 3D data of the electrode after deformation including a feature point F1 corresponds to a portion of the 3D data of the electrode before deformation including the feature point F1. Thus, it is possible to prevent a situation in which pieces of 3D data of the electrode are erroneously compared with each other, such as a case where a portion of the 3D data of the electrode after deformation is mistakenly compared with a different portion of the 3D data of the electrode before the deformation. In addition, in the event of theft of a battery, the individual identification for electrode by way of a comparison between 3D data of the electrode of the stolen battery obtained before the theft and 3D data of an electrode of a battery that appears to be the stolen battery will make it possible to determine with high accuracy whether or not the latter battery is the stolen one.

Further, according to the present embodiment, the individual identifier 13 performs individual identification of an electrode using at least one of the arrangement information regarding pieces of active materials arranged close to the feature point, the relative positional information of the feature points, or the number of current collector foils present between the plurality of feature points, as the information regarding the feature points. Thus, individual identification of the electrode can be easily and accurately performed.

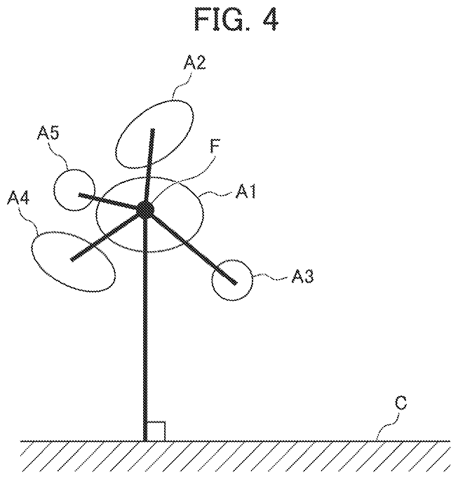

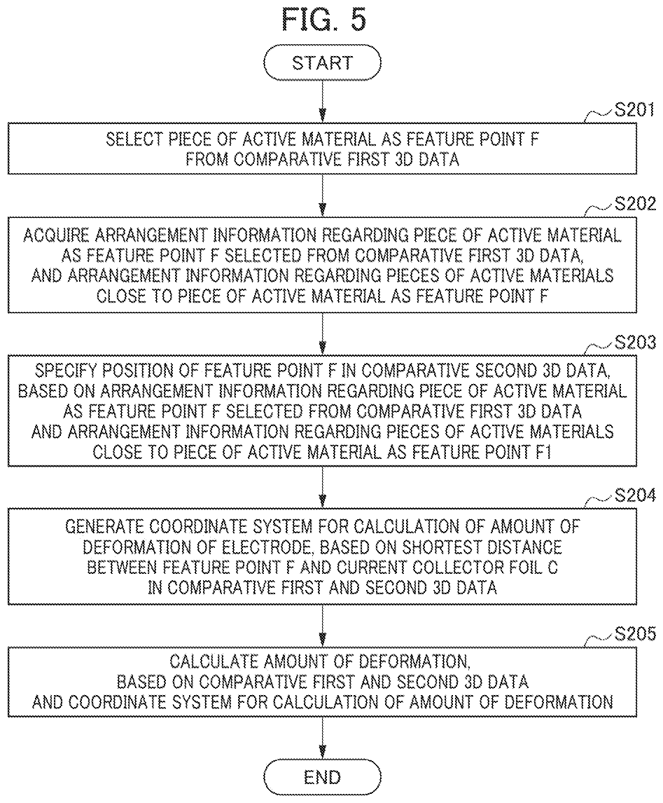

Next, a second embodiment of the present invention will be described. The second embodiment differs from the first embodiment in the identification of feature points by the feature point identifier 11. Furthermore, the second embodiment differs from the first embodiment in the generation of a coordinate system by the coordinate generator 12. Accordingly, the individual identification of an electrode by the individual identifier 13 and the calculation of an amount of expansion/contraction of the electrode by the calculator 14 in the second embodiment are different from those in the first embodiment. Since the rest of the configuration is the same or similar to that of the first embodiment, the same members are denoted by the same reference numerals, and a description thereof will be omitted. FIG. 4 is a diagram illustrating identification of a plurality of feature points by an expansion/contraction amount calculation device 1 according to the second embodiment. FIG. 5 is a flowchart illustrating calculation of an amount of deformation by the expansion/contraction amount calculation device 1 according to the second embodiment.

While the feature point identifier 11 identifies three feature points F1 to F3 in the first embodiment, only one feature point F is identified in the present embodiment. In the first embodiment, the coordinate generator 12 generates the coordinate system for calculation of an amount of deformation, based on the relative positional information regarding the three feature points F1 to F3. On the other hand, in the present embodiment, as illustrated in FIG. 4, the coordinate generator 12 generates coordinate axes having the origin at an intersection of a virtual straight line representing the shortest distance between the one feature point F and a current collector foil C of the electrode, and generates coordinates of the one feature point F.

The individual identifier 13 compares 3D data of the electrode before deformation as first 3D data including the feature point F, with 3D data of the electrode after deformation as second 3D data including the feature point F. The individual identifier 13 then performs individual identification of the electrode, based on information regarding the feature point F in the 3D data of the electrode before deformation and information regarding the feature point F in the 3D data of the electrode after deformation. For example, it is possible to use, as the information regarding the feature point F for use in the individual identification of the electrode, arrangement information regarding pieces of active materials arranged close to the feature point F.

The calculator 14 compares the 3D data of the electrode before deformation including the feature point F, with the 3D data of the electrode after deformation including the feature point F, to thereby calculate an amount of expansion/contraction and an amount of deformation of the electrode. Specifically, for example, for each of the 3D data of the electrode before deformation and the 3D data of the electrode after deformation, the calculator 14 calculates a distance between the origin and the feature point F, from the coordinates of the feature point F with respect to coordinate axes having the origin on the current collector foil C, as described above. Subsequently, the calculator 14 determines a difference between the distance in the 3D data of the electrode before deformation and the distance in the 3D data of the electrode after deformation, and thereby calculates an amount of expansion/contraction of the electrode, and then, calculates an amount of deformation based on the calculated amount of expansion/contraction.

Next, a process (control by the control device 10) will be described which is performed by the control device 10 executing a program according to the present embodiment stored in a storage medium. First, as illustrated in FIG. 5, the control device 10 controls the X-ray CT apparatus 20 so that the X-ray CT apparatus 20 scans an electrode of a battery over the entire periphery while the electrode is rotated by 360°, captures X-ray fluoroscopic images in respective directions over the entire periphery, and outputs the captured images as 3D data to the control device 10. In Step S201, the feature point identifier 11 selects a piece of an active material suitable as a feature point F from 3D data of the electrode before deformation (hereinafter referred to as “first 3D data”), and identifies the center of gravity of the piece of the active material as the feature point F. The control device 10 then proceeds to Step S202 of the process.

In Step S202, the control device 10 acquires arrangement information regarding the piece of the active material having the feature point F identified from the first 3D data and arrangement information regarding pieces of active materials arranged close to the piece of the active material having the feature point F. The control device 10 then proceeds to Step S203 of the process.

In Step S203, the control device 10 specifies a position of the feature point F in 3D data of the electrode after deformation (hereinafter referred to as “second 3D data”), based on the arrangement information regarding the piece of the active material having the feature point F and the arrangement information regarding the pieces of the active materials arranged close to the piece of active material having the feature point F, which have been identified from the first 3D data. The control device 10 then proceeds to Step S204 of the process.

In Step S204, the coordinate generator 12 of the control device 10 generates, for each of the first 3D data and the second 3D data, a coordinate system having the origin at an intersection on a current collector foil C, and generates coordinates of the feature point F with respect to the coordinate axes of the coordinate system. The control device 10 then proceeds to Step S205 of the process.

In Step S205, the calculator 14 of the control device 10 calculates an amount of deformation of the electrode by calculating an amount of expansion/contraction of the electrode based on the coordinates of the feature point F with respect to the coordinate axes generated for the first 3D data and those with respect to the coordinate axes generated for the second 3D data by the coordinate generator 12. The control device 10 then ends the process.

The present embodiment provides the following effects. In the present embodiment, the coordinate generator 12 generates a coordinate system for calculation of an amount of deformation, based on the relative positional information regarding the feature point with respect to the current collector foil, as the relative positional information. Thus, the coordinate system for calculation of the amount of deformation can be easily generated by identifying only one feature point F.

Next, a third embodiment of the present invention will be described. In the first embodiment, the feature point identifier 11 identifies the feature points from the arrangement information regarding a plurality of pieces of active materials included in the 3D data. On the other hand, the third embodiment of the present invention is directed to a case where an electrode includes a mixture containing an active material and ceramic particles, feature points are identified based on arrangement information regarding pieces of the active material and the ceramic particles. Since the rest of the configurations is the same or similar to that of the first embodiment or the second embodiment, the same members are denoted by the same reference numerals, and the description thereof will not be repeated.

The arrangement information regarding pieces of the active material and the ceramic particles includes, for example, at least one of a size, a shape, a quantity, or relative positional information of the pieces of the active material and the ceramic particles that are arranged close to one another. For example, it is possible to use, as the size and shape of the pieces of the active material and those of the ceramic particles, a ratio between a long diameter as the maximum diameter and a short diameter as the minimum diameter of the piece of the active material, and such a ratio of the ceramic particle. For example, it is possible to use, as the quantity of the pieces of the active material and that of the ceramic particles, a quantity of pieces of the active material included in a predetermined range from a predetermined piece of the active material and a quantity of the ceramic particles included in a predetermined range from a predetermined one of the ceramic particles. For example, it is possible to use, as the relative positional information of the active material and the ceramic particles, information regarding a relative position of a predetermined piece of the active material or a predetermined one of the ceramic particles with respect to another piece of the active material or another one of the ceramic particles.

The present embodiment provides the following effects. In the present embodiment, the feature point identifier 11 identifies a feature point from the arrangement information regarding the pieces of the active material and the ceramic particles. Thus, in a case of an electrode including an active material in a quantity and ceramic particles in a smaller quantity, a feature point can be easily identified because insertion and removal of ions due to charge and discharge of the battery cause substantially no change in volume.

In the present embodiment, the arrangement information regarding the pieces of the active material and the ceramic particles includes at least one of a size, a shape, a quantity, or relative positional information of the pieces of the active material and the ceramic particles that are arranged close to one another. This makes it possible to easily acquire the arrangement information regarding the pieces of the active material with higher accuracy.

While preferred embodiments of the present disclosure have been described above, the present disclosure is not limited to the above-described embodiments, and can be appropriately modified.

For example, in the above embodiment, the center of gravity F1 of the piece A1 of the active material is identified as a feature point. However, the present disclosure is not limited to this. Furthermore, in the first embodiment, the three feature points F1 to F3 are identified, but the number of feature points is not limited to three. When the number of the feature points is three or more, the feature points can be identified with higher accuracy. In the second embodiment, the coordinate axes having the origin on the current collector foil C are generated. However, for example, in a case where an amount of deformation is calculated on a cell-by-cell basis instead of an electrode-by-electrode basis, the coordinate axes may be generated such that the origin is set on, for example, a separator forming part of the battery, a laminator foil of an exterior jacket of the battery, or the like.

### EXPLANATION OF REFERENCE NUMERALS

1: Expansion/contraction amount calculation device
10: Control device
11: Feature point identifier
12: Coordinate Generator
13: Individual Identifier
14: Calculator
F1 to F3: Feature point

What is claimed is:

1. An expansion/contraction amount calculation device for calculating an amount of deformation of an electrode by calculating an amount of expansion/contraction of the electrode based on 3D data of the electrode, the 3D data including first 3D data and second 3D data, the expansion/contraction amount calculation device comprising a controller including:
a feature point identifier configured to identify a feature point from arrangement information regarding a piece of an active material, the arrangement information being included in the 3D data;
a coordinate generator configured to generate, based on relative positional information regarding the feature point, a coordinate system for calculation of the amount of deformation; and
a calculator configured to calculate, by comparing the first 3D data with the second 3D data, the amount of expansion/contraction of the electrode and the amount of deformation of the electrode.

2. The expansion/contraction amount calculation device according to claim 1, wherein
the arrangement information regarding the piece of the active material includes at least one of from a size, a shape, a quantity, or relative positional information of a plurality of the pieces of the active material that are arranged close to one another.

3. The expansion/contraction amount calculation device according to claim 1, wherein
the coordinate generator generates the coordinate system for calculation of the amount of deformation, based on relative positional information regarding the feature point with respect to a current collector foil or relative positional information regarding a plurality of the feature points, as the relative positional information.

4. The expansion/contraction amount calculation device according to claim 1, wherein
the electrode includes a mixture containing the active material and ceramic particles, and
the feature point identifier identifies the feature point from arrangement information regarding a piece of the active material and the ceramic particles.

5. The expansion/contraction amount calculation device according to claim 4, wherein
the arrangement information regarding the piece of the active material and the ceramic particles includes at least one of a size, a shape, a quantity, or relative positional information of a plurality of the pieces of the active material and the ceramic particles that are arranged close to one another.

6. The expansion/contraction amount calculation device according to claim 1, wherein
the 3D data of the electrode pertains to a partial region of an entirety of the electrode, and includes relative positional information regarding the partial region with respect to the entirety of the electrode.

7. A non-transitory computer readable medium storing an expansion/contraction amount calculation program for causing a computer to function as an expansion/contraction amount calculation device that calculates an amount of deformation of an electrode by calculating an amount of expansion/contraction of the electrode based on 3D data of the electrode, the 3D data including first 3D data and second 3D data,
the expansion/contraction amount calculation device comprising a controller including:
a feature point identifier configured to identify a feature point from arrangement information regarding a piece of an active material, the arrangement information being included in the 3D data;
a coordinate generator configured to generate, based on relative positional information regarding the feature point, a coordinate system for calculation of the amount of deformation; and
a calculator configured to calculate, by comparing the first 3D data with the second 3D data, the amount of expansion/contraction of the electrode and the amount of deformation of the electrode.

8. An individual identification device for performing individual identification of an electrode based on 3D data of the electrode, the 3D data including first 3D data and second 3D data, the individual identifier comprising a controller including:
a feature point identifier configured to identify a feature point from arrangement information regarding a piece of an active material, the arrangement information being included in the 3D data; and
an individual identifier configured to compare the first 3D data including the feature point with the second 3D data including the feature point, and to perform individual identification of the electrode based on information regarding the feature point included in the first 3D data and information regarding the feature point included in the second 3D data.

9. The individual identification device according to claim 8, wherein
the arrangement information regarding the piece of the active material includes at least one of a size, a shape, a quantity, or relative positional information of a plurality of the pieces of the active material that are arranged close to one another.

10. The individual identification device according to claim 8, wherein
the individual identifier performs individual identification of the electrode, based on at least one of arrangement information regarding pieces of the active material arranged close to the feature point, relative positional information regarding the feature point, or a number of current collector foils present between a plurality of the feature points.

11. The individual identification device according to claim 8, wherein
the electrode includes a mixture containing the active material and ceramic particles, and
the feature point identifier identifies the feature point from arrangement information regarding a piece of the active material and the ceramic particles.

12. The individual identification device according to claim 11, wherein
the arrangement information regarding the piece of the active material and the ceramic particles includes at least one of a size, a shape, a quantity, or relative positional information of a plurality of the pieces of the active material and the ceramic particles that are arranged close to one another.

13. The individual identification device according to claim 8, wherein
the 3D data of the electrode pertains to a partial region of an entirety of the electrode, and includes relative positional information regarding the partial region with respect to the entirety of the electrode.

14. A non-transitory computer readable medium storing an individual identification program for causing a computer to function as an individual identification device that performs individual identification of an electrode based on 3D data of the electrode, the 3D data including first 3D data and second 3D data,
the individual identification device comprising a controller including:
a feature point identifier configured to identify a feature point from arrangement information regarding a piece of an active material, the arrangement information being included in the 3D data; and
an individual identifier configured to compare the first 3D data including the feature point with the second 3D data including the feature point, and to perform individual identification of the electrode based on information regarding the feature point included in the first 3D data and information regarding the feature point included in the second 3D data.
